(19) United States
(12) Patent Application Publication
(10) Pub. No.: US 2007/0254269 A1
(43) Pub. Date: Nov. 1, 2007

(54) Method for Managing Dietary Habits and a System and Computer Program Therefor

(76) Inventor: Zbigniew Mlynarski, Warsaw (PL)

Correspondence Address: WELSH & KATZ, LTD, 120 S RIVERSIDE PLAZA, 22ND FLOOR, CHICAGO, IL, 60606, US

(21) Appl. No.: 10/594,000

(22) PCT Filed: Mar. 25, 2005
(86) PCT No.: PCT/PL05/00020

§ 371 Date: Jul. 9, 2007

(30) Foreign Application Priority Data
Mar. 25, 2004 (PL) P.366596

(51) Int. Cl. G09B 19/00

(52) U.S. Cl. 434/118; 434/127

(57) ABSTRACT

The invention relates to a method of managing dietary habits, a device and computer program therefore. The invention enables to develop the healthy and reasonable nutrition habits, and in particular—supplying the energy to the human organism in consumed products in quantities corresponding to the actual energy requirement of the user within minimum limitations and inconveniences which are related to the change of the diet.

### THE TECHNICAL FIELD

The invention relates to a method of managing dietary habits, a device and computer program therefor. The invention enables to develop the healthy and reasonable nutrition habits with minimum limitations and inconveniences which are related to the change of the diet. Applying the invention enables to fulfill the healthy nutrition requirements, and more particularly—to supply the energy to the human organism in consumed products in quantities corresponding to the actual energy requirement of the user and making it possible for said user to consume favorite products and dishes.

### STATE OF THE ART

There are numerous documents describing methods, devices and programs known in the prior art enabling to use the different diets, wholesome nutrition programs and slimming. For example, a method and device for the nutrition assessment is described in document JP 2002230174. According to this method the server decides whether the amount of calories taken in by consuming selected food elements remains or does not remain within the permissible range, therefore in the situation, when the amount of calories taken in is less than the lower limit of the range the server makes a choice of recipes including relatively large amount of food elements according to the nutrition evaluation described in the database, and prepares a chart which is displayed on a display, thus, in the case when the amount of calories exceeds the upper limit of the permissible range, the server makes a choice of recipes that include relatively small amount of food elements with reference to the nutrition evaluation described in the database, and then it prepares a chart and presents the table on the display.

Furthermore, a method and an apparatus for determining the energy balance of a living subject on the basis of the energy use and the nutrition intake is disclosed in document U.S. Pat. No. 5,989,188. According to the description, the energy balance is calculated on the basis of the fixed energy intake by the tested living subject as well as on the basis of food which is supplied to the living subject by the supply unit. The calculation takes place in a calculation unit supplied with a signal corresponding to the energy use, whereby by calculations the food caloric values recorded in the memory are used, and then a signal corresponding to the energy balance is presented on a display. Furthermore, document JP 10222490 discloses a device for managing nutrition in which after introducing the fixed energy value to it, the device sorts out and distributes fixed energy value which should be collected during one day in appropriate food products and appropriate meals. The fixed energy amount is indicated in units of 80 kcal. The suggested products are presented on charts on a display, and by moving the cursor on the visual display unit for one day appropriate fragments of distributing the fixed energy between meals and the list of food products corresponding with it are sequentially presented on the display.

It is known in the prior art that the documents setting adequate or recommended values of energy supplied to the human organism within a fixed period of time take into consideration such factors as age, weight, height, activity level, etc., but doesn't comply the fact of the functional time-dependency of the absorption velocity of the alimentary components supplied in meals, from which the human organism gets the energy.

### DISCLOSURE OF THE INVENTION

Surprisingly it has been found that recording the changes of the function being a time dependency of absorption velocity of alimentary components supplied in food from which the human organism obtains energy as well as the function itself, can be used in a method for managing dietary habits as well as in a system and a computer program therefor. The graphical form of the course of this function is particularly useful. The function in such form illustrates the absorption velocity of alimentary components from which in a predetermined period of time a human organism gets the energy as a result of digesting food. Such a function is determined by preliminary parameters which comply, among others, a diversification of the digestion velocity of the three basic sources of food energy such as carbohydrates, fats and proteins as well as partial utilization of the consumed proteins as a building material, a diversified digestion velocity of digestion of carbohydrates which are reflected by a value of glycemic index, etc. The area under the curve for the chosen period of time corresponds to the amount of energy supplied to the human organism in that period of time as a result of alimentary components digestion from which the human body derives the energy.

The object of the invention is a method for managing dietary habits, characterized in that:
the required energy supply during the specific period of user's activity is defined,
information concerning the consumed products and times of consuming is introduced,
energy supplies to the human organism are calculated basing on the information concerning the energy content in food products and absorption velocity of alimentary components supplied in food from which human organism gets its energy.

According to the preferred embodiment of the invention the periods of adequate nutrition, malnutrition and excessive nutrition are determined.

According to the preferred another embodiment of the invention the requirement for the daily energy supply from the awakening to the falling asleep of a user is determined. Preferably, the requirement for energy is determined by dividing the period of activity into smaller units determining the energy which should be supplied in each unit.

According to the next preferred embodiment of the invention the requirement for the energy supply is presented in a form of a diagram which shows the maximum and minimum supplies of energy in the time of activity period.

According to still another preferred embodiment of the invention after the calculation the energy supplies to the human organism are presented in the form of a diagram illustrating the energy supplies during the time of activity period. Preferably, the periods of malnutrition and excessive nutrition are indicated in diagram.

According to the next preferred another embodiment of the invention, a list of recommended dishes is presented taking into consideration the information concerning the health state of the user. Preferably, the information concerning the health state of the user includes the information concerning particular inclinations of the user including the inclination to obesity.

According to another preferred another embodiment of the invention the list of recommended dishes is presented taking into consideration the information concerning the user's activity. Preferably, the information concerning the user's activity includes the information concerning the changes of the user's lifestyle.

Further object of the invention is a system for managing dietary habits, characterized in that it contains the following:
a storage element for storing information about the requirements for energy supplies during the specific activity period and for storing information about products, said information concerning the energy content and the velocity of the energy supplied to the human organism after consuming these products;
a loading element for loading information concerning the consumed products;
an analytical element for calculating the quantity of energy supplied to the human organism as the result of digesting the alimentary components from which the human organism draws the energy during the time of the active period and for the identifying the periods of malnutrition and excessive nutrition;
a displaying element for displaying the amount of energy supplied to the human organism at that specific period of time as a result of digesting the alimentary components from which the human organism draws the energy and periods of adequate nutrition as well as periods of malnutrition and excessive nutrition.

Furthermore, the object of the invention is also a computer program for managing dietary habits, characterized in that comprises the following programming code modules recorded on a data carrier readable by means of a computer:
a storage module for storing information about the requirements for the energy supplies during the specific activity period and for storing of information about products, said information concerning the energy content and the velocity of the energy supplied to the human organism after consuming these products;
a loading module for loading information concerning the consumed products;
an analytical module for calculating the quantity of energy supplied to the human organism as the result of digesting the alimentary components from which the human organism draws the energy during the time of the activity period and for the identifying the periods of malnutrition and excessive nutrition;
a display module for displaying the amount of energy supplied to the human organism during the period of time as a result of digesting the alimentary components from which the human organism draws the energy and periods of adequate nutrition as well as periods of malnutrition and excessive nutrition.

Preferably the computer program for managing dietary habits serves to implement the method according to the invention.

The invention is illustrated by means of the following example and the drawing enclosed, in which:

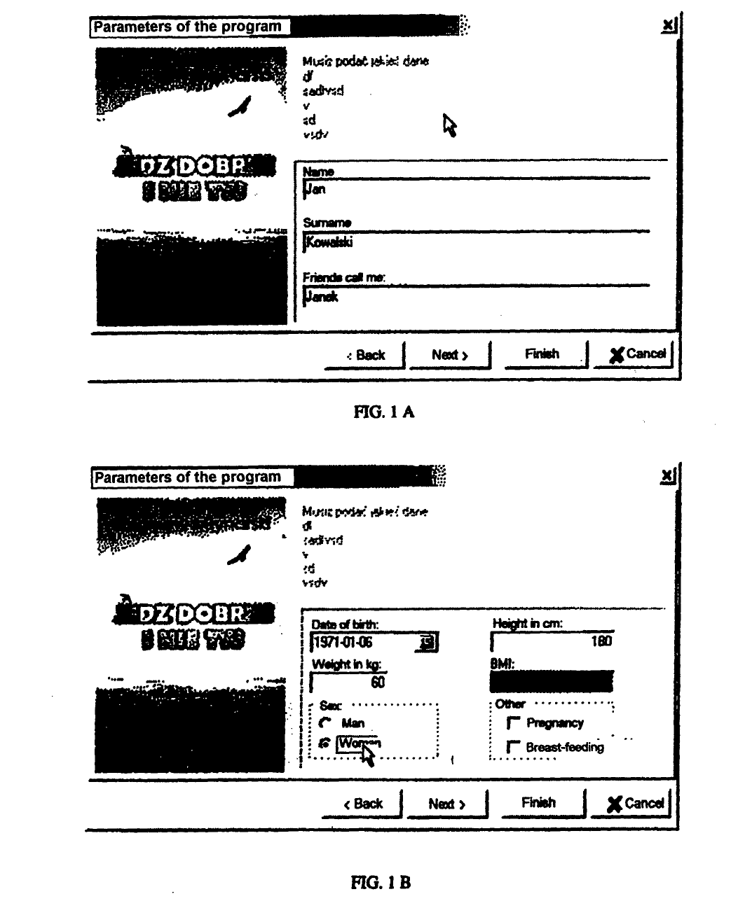

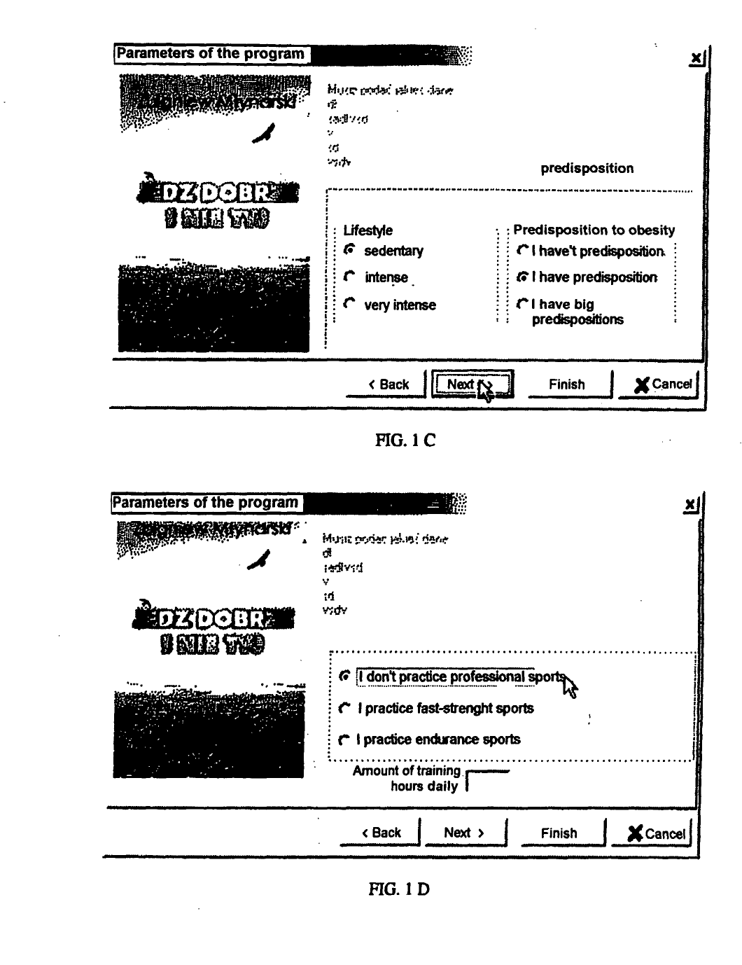

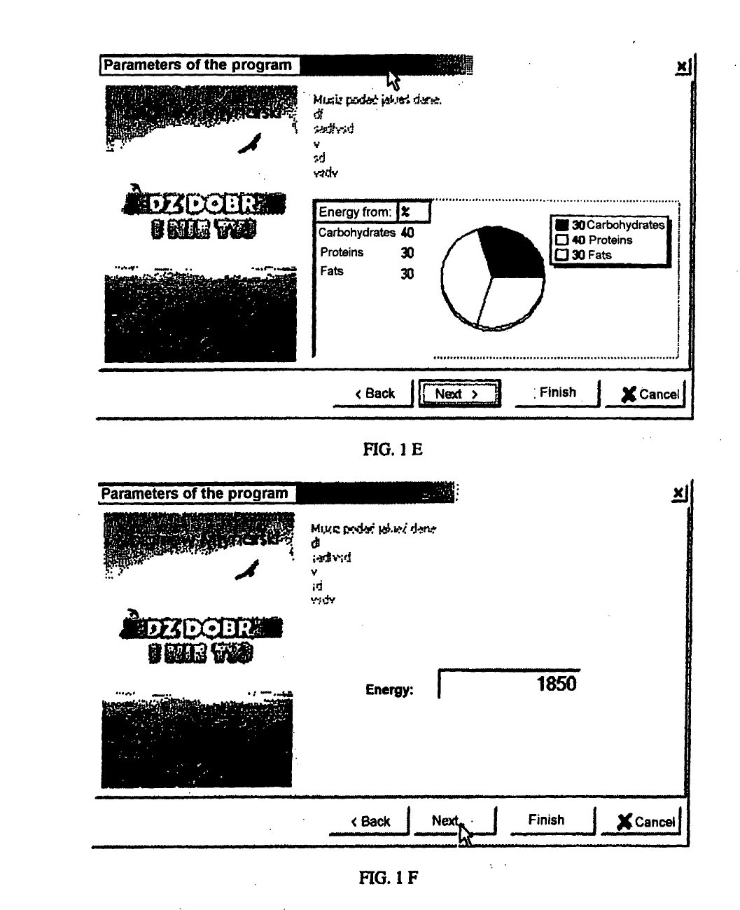

FIG. 1 shows a form for loading or modifying the user's data;

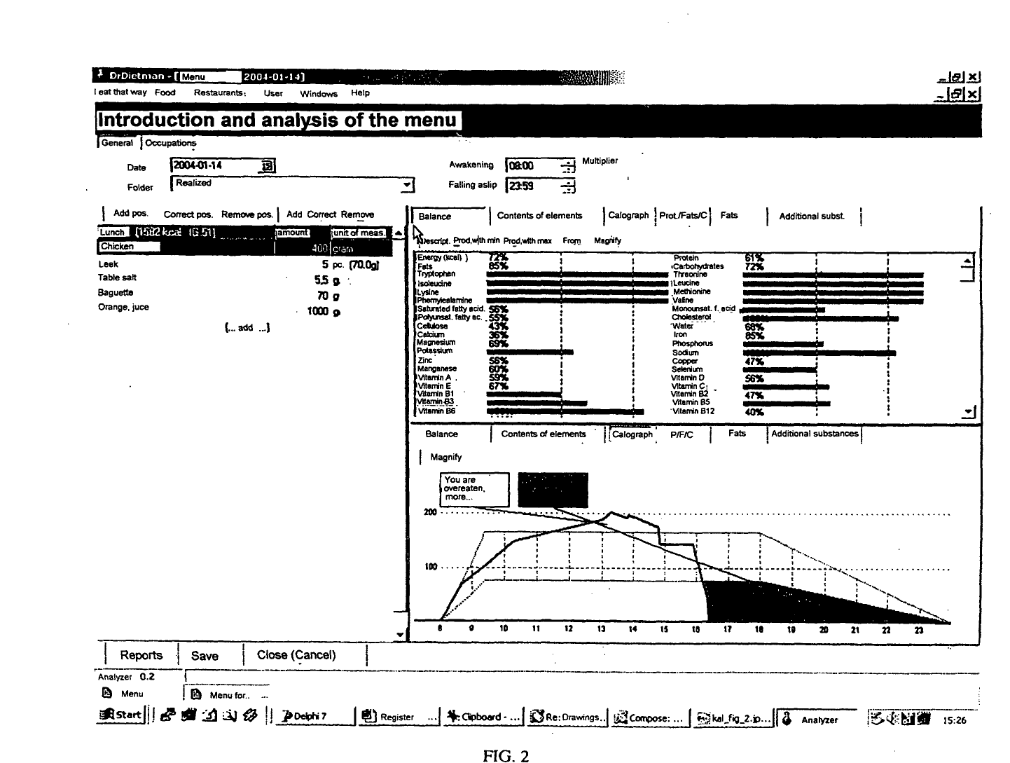

FIG. 2 shows a realized menu together with the analysis of consumed products in the form of a diagram which shows the course of the functional time-dependency of velocity of absorbing energy supplied in food.

### EXAMPLE 1

The Usage of a Computer Program According to the Invention for Realization of the Method According to the Invention.

The use of the computer program for the method for managing dietary habits according to the invention can be divided into two stages: the primary preparation of the program for the use of the specific user and the stage of the actual use of the program by that user.

In the first stage, essential information for supplying food to the user is introduced establishing the recommended quantity of energy. This data in particular contains age, height, weight, sex (in the case of women it is also possible to choose and mark one of the options: “pregnancy” or “breast-feeding”) or lifestyle (you can choose one out of three or four options, for women or men, respectively). The form for loading or modifying data concerning the user is shown in FIG. 1.

At this stage also the information concerning the energy supply requirements of the specific user during a certain activity period is inserted into the storage module. For example, this stage includes a day, in the meaning of time, from the awakening to falling asleep of the user. Accordingly, the loaded data relates to the hour of waking up and the hour of falling asleep as well as the inclination to obesity, which is chosen from three options (lack/small/large). Knowing how much energy the human organism uses during the sleep the system establishes the quantity of energy which is in normally used by the user during his/her activity period. The quantity is marked as the minimum which should be supplied to the user's food. The system establishes the maximal level of energy supplied from food taking into consideration the food from which the supplies must be accumulated and which are needed for producing energy in the period of sleep. It is assumed that the human organism gains the ability to make use of the energy from the food in a certain time after the awakening and gradually loses it in a certain time before falling asleep. The maximal as well as the minimal levels of recommended supplies of the alimentary components from which the human body draws energy during the hours when the human organism is capable of the total use of energy from food is presented in a diagram in the form of horizontal lines in the coordinate system of the velocity of alimentary components absorption from which the human body derives its energy vs. time.

The inclination to obesity declared by the user is important for establishing the exceeding of the maximal permissible level supplies of alimentary components in which the organism gets the energy. The exceeding of maximal permissible level supplies results from the ability of a human organism to adapt to the increased quantity of alimentary components. In the described example it has been assumed that if for subjects that have a serious inclination to obesity the factor is 1 (the user's organism is able to adapt the energy consumption to the quantity of energy supplied to the it as a result of digesting the alimentary components only to a small extent), then for subjects that have a small inclination to obesity the factor is e.g. 1.5 and for subjects that do not exhibit the inclination to obesity at all the factor is e.g. 2. That means that the organism of a subject that does not exhibit inclination to obesity is able to adapt the consumption energy to the quantity of energy supplied to the human body as a result of digesting the alimentary components in quite a broad range.

The second stage is related to the actual use of the computer program by the user and includes inserting the information concerning consumed products by means of a loading module. This information includes the name and the quantity of the consumed product. The product may be chosen from the list of products which is in the information storage module with indication of the appropriate quantity of products or a new product can be introduced together with the determination of quantity of energy in a certain quantity of that product. The information also includes the time of consumption of the product. Then the system calculates the approximate velocity of the absorption of alimentary components supplied in food from which the organism draws the energy. The maximal absorption velocity of the particular alimentary components which serve as energy supplies is taken into consideration. It is assumed that the maximal absorption velocity for carbohydrates is 320 kcal/h, for fates 150 kcal/h and for proteins 58 kcal/h. Then the factors that influence the reduction of the velocities are taken into account. In case of using the diagrams for practical purposes, with the exception of the analysis results in scientific research, only the following factors are assumed:
the influence of the body mass,
the reduction of absorption velocity which is related to the presence of fat or cellulose in the given meal, whereby the glycemic index of the carbohydrates is taken into consideration,
information based on the assumption as to what part of the consumed proteins is used for building purposes and what part act as the energy source for the organism.

The time also is taken into consideration after which the maximal velocity of the particular components absorption is attained.

Knowing the absorption velocity of the particular energetic alimentary components and quantity the position on the diagram of the curve of the absorption velocity of the particular alimentary components from which the human body draws the energy is calculated, taking into consideration the quantity in which the component was consumed. Then the area under the curve corresponds to the amount of energy supplied to the organism in a certain time as a result of digesting the alimentary components from which the organism draws the energy. The diagrams concerning particular components are joined and presented by means of the presentation module. The calculation result is presented in a form of a diagram of dependence functional velocity of energy absorption which is supplied in food versus time (so-called calograph). A hypothetical diagram of the above interrelation is presented in FIG. 2.

The range of the recommended quantity of energy supplied to the organism as a result of digesting the alimentary components of food discussed above is marked in the diagram. In the background of the range the course of function illustrating the approximate course of velocity of the absorption of alimentary components from which the human body draws the energy—versus time is presented. In the case in which the curve is situated below the lower limit of the mentioned range, a message appears which informs the user about the malnutrition, i.e. about the fact that in the given period of time the human body received less energy than it needed at that time. Similarly, when the curve crosses upper limit of the range then a massage appears concerning the excessive alimentation within the given period of time. Additionally, a message may also appear concerning the pancreas overload when the consumption of the products by the user which have defined (usually high) glycemic index crosses the certain critical value, above which in people with insulin-resistance, a sudden secretion of the excessive quantity of the insulin to the organism takes place. The presented massages also include basic information about the meaning of indicated deviations from the recommended quantity of energy supplied to the human body as a result of digesting the alimentary components and the possible salubrious consequences.

What is claimed is:

1. A method for managing dietary habits, characterized in that:
the required energy supply during the specific period of user's activity is defined,
information concerning the consumed products and times of consuming is introduced,
energy supplies to the human organism are calculated basing on the information concerning the energy content in food products and absorption velocity of alimentary components supplied in food from which human organism gets its energy.

2. The method according to claim 1, characterized in that the periods of adequate nutrition, malnutrition and excessive nutrition are determined.

3. The method according to claim 1, characterized in that the requirement for the daily energy supply from the awakening to the falling asleep of a user is determined.

4. The method according to claim 3, characterized in that the requirement for energy is determined by dividing the period of activity into smaller units determining the energy which should be supplied in each unit.

5. The method according to claim 1, characterized in that the requirement for the energy supply is presented in a form of a diagram which shows the maximum and minimum supplies of energy in the time of activity period.

6. The method according to claim 1, characterized in that after the calculation the energy supplies to the human organism are presented in the form of a diagram illustrating the energy supplies during the time of activity period.

7. The method according to claim 6, characterized in that the periods of malnutrition and excessive nutrition are indicated in diagram.

8. The method according to claim 1, characterized in that a list of recommended dishes is presented taking into consideration the information concerning the health state of the user.

9. The method according to claim 8, characterized in that the information concerning the health state of the user includes the information concerning particular inclinations of the user including the inclination to obesity.

10. The method according to claim 1, characterized in that the list of recommended dishes is presented taking into consideration the information concerning the user's activity.

11. The method according to claim 10, characterized in that the information concerning the user's activity includes the information concerning the changes of the user's lifestyle.

12. A system for managing dietary habits, comprising:
a storage element for storing information about the requirements for energy supplies during the specific activity period and for storing information about products, said information concerning the energy content and the velocity of the energy supplied to the human organism after consuming these products;
a loading element for loading information concerning the consumed products;
an analytical element for calculating the quantity of energy supplied to the human organism as the result of digesting the alimentary components from which the human organism draws the energy during the time of the active period and for the identifying the periods of malnutrition and excessive nutrition;
a displaying element for displaying the amount of energy supplied to the human organism at that specific period of time as a result of digesting the alimentary components from which the human organism draws the energy and periods of adequate nutrition as well as periods of malnutrition and excessive nutrition.

13. A computer program for managing dietary habits, comprising the following programming code modules recorded on a data carrier readable by a computer:
a storage module for storing information about the requirements for the energy supplies during the specific activity period and for storing of information about products, said information concerning the energy content and the velocity of the energy supplied to the human organism after consuming these products;
a loading module for loading information concerning the consumed products;
an analytical module for calculating the quantity of energy supplied to the human organism as the result of digesting the alimentary components from which the human organism draws the energy during the time of the activity period and for the identifying the periods of malnutrition and excessive nutrition;
a display module for displaying the amount of energy supplied to the human organism during the period of time as a result of digesting the alimentary components from which
the human organism draws the energy and periods of adequate nutrition as well as periods of malnutrition and excessive nutrition.

14. The computer program for managing dietary habits, characterized in that it serves to implement the method according to claim 1.

15. The method according to claim 5, characterized in that after the calculation the energy supplies to the human organism are presented in the form of a diagram illustrating the energy supplies during the time of activity period.

16. The computer program for managing dietary habits, characterized in that it serves to implement the method according to claim 12.

17. The computer program for managing dietary habits, characterized in that it serves to implement the method according to 13.
